(19) United States
(12) Patent Application Publication
(10) Pub. No.: US 2010/0279755 A1
(43) Pub. Date: Nov. 4, 2010

(54) CHARACTERS IN THREE-DIMENSIONAL GAMING SYSTEM ENVIRONMENTS

(76) Inventors: Larry Pacey, Chicago, IL (US); Jeremy Hornik, Chicago, IL (US)

Correspondence Address: SCHWEGMAN, LUNDBERG & WOESSNER/WMS GAMING, P.O. BOX 2938, MINNEAPOLIS, MN, 55402, US

(21) Appl. No.: 12/063,636

(22) PCT Filed: Aug. 3, 2006
(86) PCT No.: PCT/US06/30188

§ 371 Date: Feb. 12, 2008

Related U.S. Application Data
(60) Provisional application No. 60/707,610, filed on Aug. 12, 2005.

(51) Int. Cl. A63F 9/24; A63F 13/00

(52) U.S. Cl. 463/6; 463/32

(57) ABSTRACT

Methods and apparatus affecting the interaction between characters and a three-dimensional wagering game environment are described herein.

### RELATED APPLICATIONS

This application claims the priority benefit of U.S. Provisional Application Ser. No. 60/707,610 filed Aug. 12, 2005, the contents of which are incorporated herein by reference.

This disclosure is related to pending U.S. Provisional Patent Application Ser. No. 60/707,707, titled “Three-Dimensional Gaming System Environments”, filed on Aug. 12, 2005, owned by WMS Gaming Inc., and incorporated herein by reference in its entirety.

### TECHNICAL FIELD

The material disclosed by this document pertains generally to wagering game systems, including apparatus, systems, and methods for displaying three-dimensional effects and character interactions in a wagering game machine.

### COPYRIGHT

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2005, 2006, WMS Gaming, Inc.

### BACKGROUND INFORMATION

Wagering game makers labor continually to provide new and entertaining games. For example, pick games and reel-based games are popular. In a pick game, the player chooses from a number of selections. The selection then triggers particular gaming outcomes. In reel-based games, mechanical or simulated slot reels can be rotated and stopped to place symbols on the reels in visual association with one or more pay lines. If the selected outcome is one of the winning outcomes defined by a pay table, the processor may award the player with a number of credits associated with the winning outcome.

One conventional way of increasing the entertainment value associated with casino-style wagering games (e.g., slots, poker, black jack, roulette, bingo, keno, and the like) includes offering a base game and a variety of bonus events. Thus, pick games may be used alone, or in combination with reel-based games to provide bonus events. Bonus events may occur outside the reel spin, for example, injecting a random event, or perhaps fostering player interaction to trigger a random event.

Whatever type of game is involved, players tend to become disinterested in repetitive base games and bonus events. Thus, in order to maintain player interest, there is a need for wagering game machine makers to update game themes, game settings, and bonus events, as well as opportunities for player-game interaction.

### BRIEF DESCRIPTION OF THE DRAWINGS

FIG. 1 illustrates a gaming machine apparatus according to various embodiments of the present invention.

FIG. 2 illustrates apparatus and systems, including an article of manufacture, according to various embodiments of the invention.

FIG. 3 is a block diagram of an exemplary wagering game network in accordance with various embodiments of the invention.

FIG. 4 is a flow diagram illustrating several methods according to various embodiments of the invention.

### DETAILED DESCRIPTION

In some embodiments of the invention, the challenges described above may be addressed by implementing apparatus, systems, and methods that affect the interaction between characters, gaming outcomes, and three-dimensional visual environments in a wagering game.

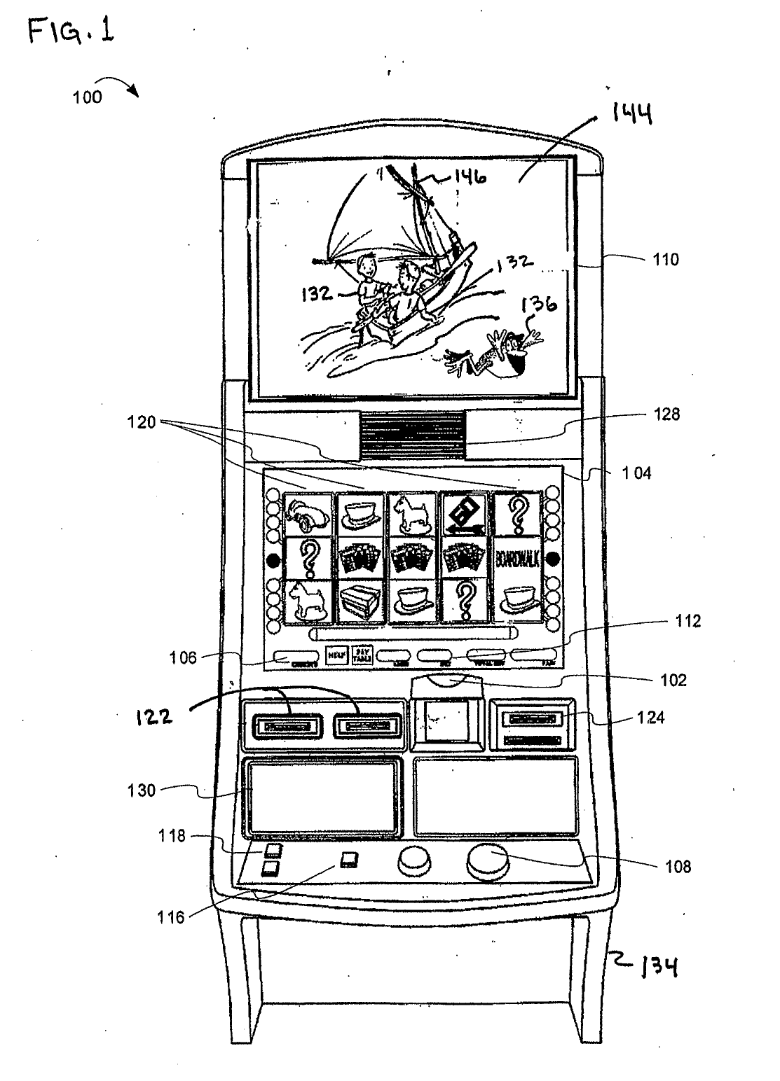

FIG. 1 illustrates a gaming machine 100 apparatus according to various embodiments of the present invention. As shown in FIG. 1, the gaming machine 100 may include a computerized slot machine having the controls, displays, and features of a conventional slot machine, if desired.

The gaming machine 100 can be operated while players are standing or seated. Additionally, the gaming machine 100 may be mounted on a stand (not shown). The gaming machine 100 may also be constructed as a pub-style tabletop game (not shown), which a player can operate while sitting. Furthermore, the gaming machine 100 can be constructed with varying enclosure (e.g. a floor-standing cabinet or a hand-held unit) and display designs. The gaming machine 100 can incorporate any primary game such as slots, poker, black-jack, bingo, roulette, or keno, and additional bonus round games. The symbols and indicia used on and in the gaming machine 100 can take mechanical, electrical, or video form.

As illustrated in FIG. 1, the gaming machine 100 may comprise a wagering gaming machine, perhaps including a coin slot 102 and/or bill acceptor 124. Players can place coins in the coin slot 102 and paper money or ticket vouchers in the bill acceptor 124. Other devices can be used for accepting payment. For example, credit/debit card readers/validators 122 can be used for accepting payment. Additionally, the gaming machine 100 can perform electronic funds transfer operations and financial transfers to procure monies from financial accounts.

In any case, when funds become available, such as after a player inserts money in the gaming machine 100, the number of credits corresponding to the amount deposited are shown in a credit display 106. After providing the appropriate amount of money, a player can begin playing the game by operating a player input device 108, which may comprise a joystick, a play button, a touch screen, a trackball, a capacitive switch, a microphone, a camera, or any other device capable of being used to start a wagering game, or influence the sequence of events in a wagering game conducted by the gaming machine 100.

As shown in FIG. 1, the gaming machine 100 also includes a bet display 112 and a “bet one” button 116. The player may place a bet by pushing the bet one button 116. The player can also increase the bet by one credit each time the player pushes the bet one button 116. When the player pushes the bet one button 116, the number of credits shown in the credit display 106 may decrease by one credit, while the number of credits shown in the bet display 112 may increase by one credit. Other incremental amounts of credit may be attributed to the credit display 106 and the bet display 112 by activating the bet one button, if desired.

A player may end the course of play or “cash out” by pressing a cash out button 118. When a player cashes out, the gaming machine 100 may dispense a voucher or currency corresponding to the number of remaining credits. The gaming machine 100 may employ other payout mechanisms, such as credit slips (which are redeemable by a cashier), electronically recordable cards (which track player credits), and electronic funds transfer, among others.

The gaming machine 100 may include a primary display unit 104, and perhaps a secondary display unit 110 (also known as a “top box”). The gaming machine 100 may also include an auxiliary video display 130. In one embodiment, the primary display unit 104 is used to display a plurality of video reels 120. According to some embodiments of the invention, the display units 104 and 110 can include any visual representation or exhibition, including moving physical objects (e.g., mechanical reels and wheels), dynamic lighting, and video images, including characters 132 and three-dimensional environments 144. In some embodiments, each reel 120 includes a plurality of symbols such as bells, hearts, fruits, numbers, letters, bars or other images, including characters, which correspond to a theme associated with the gaming machine 100. Furthermore, as shown in FIG. 1, the gaming machine 100 may include an audio presentation unit 128. The audio presentation unit 128 can include audio speakers or other suitable sound projection devices.

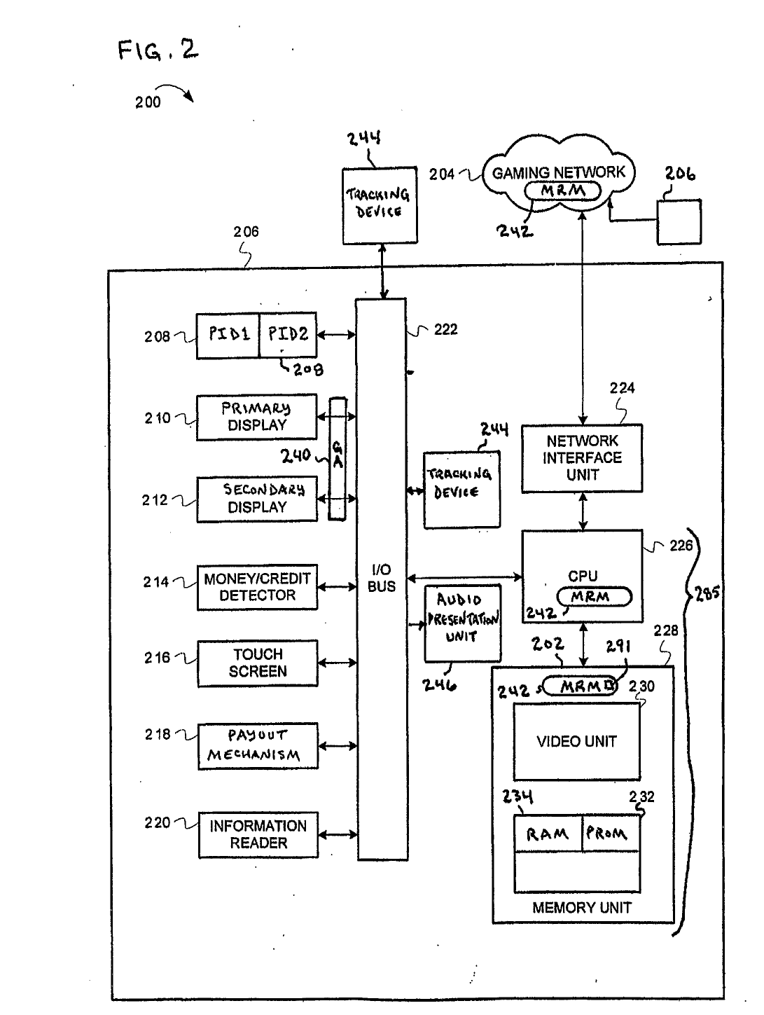

FIG. 2 illustrates apparatus and systems, including a gaming machine 206 and an article of manufacture 202, according to various embodiments of the invention. The gaming machine 206 may be similar to, or identical to the gaming machine 100 (see FIG. 1), discussed previously.

As shown in FIG. 2, the gaming machine 206 may include one or more central processing units (CPUs) 226 connected to a memory unit 228, which can include a volatile memory 234 (e.g., random access memory (RAM)) and a nonvolatile memory 232 (e.g., programmable read only memory (PROM)). The CPU 226 may also be connected to a network interface unit 224 (e.g., wired or wireless) that, in turn, may be coupled to a gaming network 204, such as a serverless gaming network.

The CPU 226 may also be connected to an input/output (I/O) bus 222. The I/O bus 222 can be connected to one or more player input devices 208, one or more displays, such as a primary display 210 and a secondary display 212, a money/credit detector 214, a touch screen 216, a payout mechanism 218, and an information reader 220, and an audio presentation unit 246 (similar to or identical to the audio presentation unit 128 of FIG. 1). A graphics accelerator 240 may be coupled between the I/O bus 222 and the displays 210, 212. In this way, the I/O bus 222 can be used to facilitate communication between the system components and the CPU 226.

Thus, according to some embodiments, the gaming machine 206 can include additional peripheral devices and/or more than one of the components shown in FIG. 2. For example, in one embodiment, the gaming machine 206 may include multiple network interface units 224 and multiple CPUs 226. Additionally, the components of the gaming machine 206 can be interconnected according to any suitable interconnection architecture (e.g., directly connected, hypercube, etc.).

According to some embodiments, any element of the gaming machine 206 may include machine-readable media 242 with instructions stored thereon for conducting a basic wagering game, conducting a bonus game, and storing and/or transmitting non-monetary player information in a gaming network 204. Machine-readable media 242 includes any mechanism that provides (i.e., stores and/or transmits) information in a form readable by a machine (e.g., a computer or processor). For example, a machine-readable medium 242 may include ROM, PROM, RAM, magnetic disk storage media, optical storage media, flash memory devices, electrical, optical, acoustical, or other forms of propagated signals (e.g., carrier waves, infrared signals, digital signals, etc.). According to some embodiments of the invention, the gaming machine 206 and other components of the gaming network 204 can include other types of logic (e.g., digital hardware logic and/or firmware) for executing the operations described herein.

The gaming machine 206 can present any type of pick game or casino style wagering game, such as poker, black jack, slots, bingo, roulette, keno, etc. In one embodiment, the wagering games can include a base game and a bonus game. When executing the base game, the gaming machine 206 can present a plurality of symbols that indicate a randomly selected outcome, which is selected from a plurality of outcomes. For example, when presenting a video slots game to a player, the gaming machine 206 can present a set of reel symbols that indicates the game's outcome. Based on the outcome, the gaming machine 206 can provide monetary awards and non-monetary assets for acquisition by the player, or a proxy for the player (e.g., a magnetic card, or a second player designated by the first player).

Non-monetary assets can represent any feature or element of a base game or an associated bonus game. When the base and bonus games are presented in conjunction with a theme, the non-monetary assets can represent objects related to the theme. For example, for base and bonus games based on the Hasbro Inc. Monopoly® board game, non-monetary assets can represent elements of the board game, such as properties shown on the game board, houses, hotels, Chance cards, Community Chest cards, etc. As another example, for base and bonus games based on the Hollywood Squares™ television show, non-monetary assets can represent Xs or Os on a tic-tac-toe board.

According to some embodiments, non-monetary assets can be used for initializing and conducting base and bonus games. For example, after a player accumulates a certain combination of non-monetary assets (referred to herein as an awarded set of non-monetary assets), the gaming machine 206 can present a bonus game based on the non-monetary assets. For example, the gaming machine 206 can initialize, conduct, and display a three-dimensional Monopoly® bonus game environment based on properties and houses a player “owns” (i.e., the player's non-monetary assets). In one embodiment, the non-monetary information set used for initializing the bonus game is referred to as a “bonus-starting” set.

In addition to awarding and tracking non-monetary assets, the gaming machine 206 can track and modify other non-monetary information, such as player tracking information, casino preferences, and player preferences. Non-monetary information can also include any other information relating to a base game or bonus game.

According to some embodiments, player tracking information can include information about a player's playing habits. For example, the player tracking information can include dates and times games were played, money wagered, wagering patterns, money won, money lost, gaming machines used, and other player information.

Casino preferences can include information for configuring certain aspects of a game. Casino preferences can include information about maximum wagers, minimum wagers, bet one increments, game duration, maximum losses allowed for a player, and other casino related information.

Player preferences can include information used for configuring certain aspects of a game. For example, player preferences can include background music, game color scheme, volume, bonus game preferences, etc.

The gaming machine 206 can track players and their non-monetary player information (including non-monetary assets) using tickets, vouchers, electronic cards, etc. In one embodiment, the gaming machine 206 stores in a local persistent storage device (e.g., the gaming device's non-volatile PROM) a set of non-monetary player information accumulated during a player gaming session. The gaming machine 206 also stores a unique identifier associated with the player and the set of non-monetary player information. According to some embodiments, when a player terminates a gaming session, the gaming device 206 prints a voucher bearing the unique identifier. If the player uses the ticket to initiate another gaming session on a node (e.g., any gaming machine 206) on the gaming network 204, the node can request and receive from the original gaming machine 206 the set of non-monetary player information associated with the unique identifier stored in the PROM. Of course, such information may be previously uploaded and stored in a medium 242 located in the network 204. As a result, the player may have access to accumulated non-monetary player information including non-monetary assets from a number of nodes (e.g., any gaming machine 206) on the gaming network 204, which may comprise a global computer network, including the Internet.

In addition to using tickets for tracking non-monetary player information, embodiments of the gaming machine 206 can also use biometric devices, smart cards, magnetic cards, radio frequency identification (RFID) tags, and/or any other suitable player-tracking device 244. For embodiments that use player-tracking devices 244, the unique identifier associated with the player's non-monetary player information may be stored in the player-tracking device 244. If the player presents the player tracking device 244 bearing the unique identifier, perhaps inserting it into a slot in the gaming machine 206 so as to couple the player-tracking device 244 to the I/O bus 222, the gaming network 204 may provide the non-monetary player tracking information associated with the unique identifier to any node on the network 204 (e.g., any gaming machine 206 coupled to the network 204).

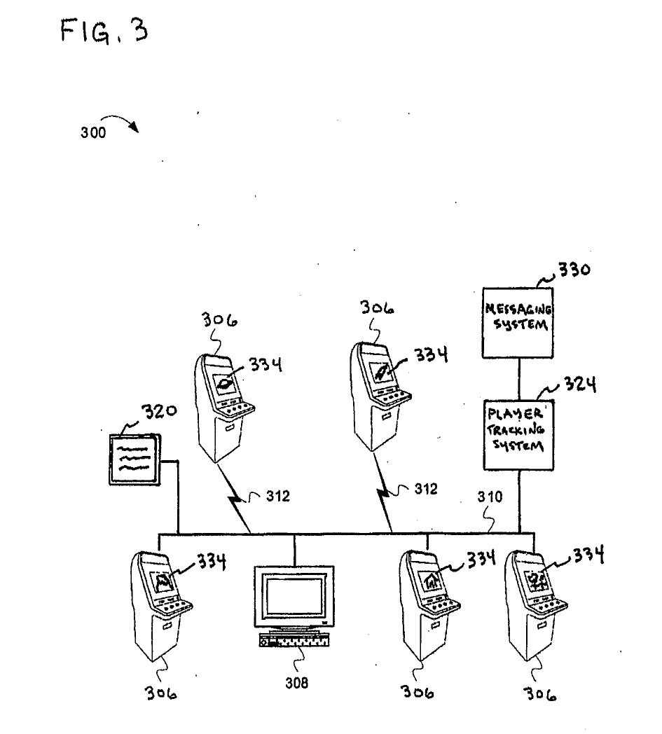

FIG. 3 is a block diagram of an exemplary wagering game network 300, in accordance with various embodiments of the invention. The wagering game network 300 may be similar to or identical to the gaming network 204, and may include a plurality of wagering game machines 306 (similar to or identical to the wagering game machine 206 in FIG. 2), as well as one or more cluster controllers 308. These components of the wagering game network 300 can communicate over wired connections 310 and/or wireless connections 312. The wagering game machines 306 can be coupled to the wagering game network 300 using any suitable wired or wireless connection technology, such as Bluetooth, 802.11x, Ethernet, etc.

Cluster controllers 308 can be used for monitoring the operation of the wagering game machines 306 and/or controlling game machine related systems, such as wide-area progressive games, player tracking systems, and casino messaging systems. Thus, in some embodiments, the wagering game machines 306 can be part of a wide-area progressive game.

For example, in certain embodiments, the cluster controller 308 can accumulate and distribute progressive jackpots, while the wagering game machines 306 can determine whether players have won the progressive jackpots. Because progressive jackpots steadily increase as more wagers are placed, displaying progressive jackpots can attract players to the wagering game machines 306. According to some embodiments, the wagering game machines 306 can receive updated jackpot amounts from the cluster controller 308 and present the jackpot amounts on display devices 320, such as a group of flat-panel displays, or a wide-screen television.

In some embodiments, the gaming network 300 includes a player tracking system 324. Player tracking systems 324 can be used to obtain information about player demographics and playing habits. Player tracking systems 324 may use player-tracking devices (e.g., player-tracking devices 244 of FIG. 2) to assist in acquiring player information. As noted above, player-tracking devices can include magnetic cards, flash memory devices, smart cards, RFID modules, or any device, including a portable device, suitable for storing player information.

At the beginning of a gaming session, players may provide player information by inserting player tracking devices into the wagering game machines 306, as described previously. Certain devices, such as RFID modules, may permit reading the information as soon as a player approaches within a selected distance of a gaming machine 306. The player tracking device may provide any type of information, including a player's name, age, gender, address, zip code, account number, prior winnings, etc. During the gaming session, the cluster controller 308 may record the time of day, duration of play, wager amounts, number of games played, and other information about a player's playing habits. Casinos can use the player tracking information to reward players, as well as to market goods and services to specific players.

Player tracking systems 324 may present text messages on auxiliary video displays (e.g., video unit 230 in FIG. 2) that form a part of the wagering game machines 306. The auxiliary displays may comprise character-limited (e.g., twenty character) scrolling text displays or miniature liquid crystal displays (LCDs), as well as more conventional flat-panel or cathode ray tube (CRT) displays. The text messages can include product promotions and other marketing content.

Player tracking systems 324 can also work with casino messaging systems 330 to facilitate delivery of text messages to players at the wagering game machines 306. In particular, casino messaging systems 330 can be used for presenting “harm minimization” or “responsible gaming” messages. Such messages may suggest player rest periods or notify players about amounts wagered or lost. In some gaming jurisdictions, authorities require casino messaging systems 330 to present responsible gaming messages. Casino messaging systems 330 can also present emergency safety messages.

Embodiments of the invention can expand the usefulness of player tracking and casino messaging systems 330. Among other things, certain embodiments allow player tracking systems 324 and casino messaging systems 330 to present multimedia messages, instead of scrolling text messages. Additionally, instead of being limited to small add-on displays (e.g., miniature LCDs, etc.), some embodiments allow player tracking systems 324 and casino messaging systems 330 to present the multi-media messages on the wagering game machines' primary displays, secondary displays, and/or audio presentation units (e.g., elements 210, 212, and 246 of FIG. 2, respectively). Furthermore, some embodiments allow wagering game machines 306 to present responsible gaming messages without any further modification or inspection by gaming authorities.

While the previous discussion has focused on some of the mechanisms that may be used in various embodiments, especially with respect to hardware for gaming machines and gaming networks, the following will provide some additional detail with respect to additional embodiments that can affect the interaction between characters, gaming outcomes, and three-dimensional visual environments in a wagering game.

Referring now to FIGS. 1, 2, and 3, it can be seen that a wagering game system 200 (which may comprise one or more gaming machines 100, 206, 306, or a gaming network 204, 300) may include one or more player-input devices 108, 208, one or more displays 104, 110, 210, 212, 230, and one or more processors (e.g., CPU 226). The processors may be used to conduct a wagering game responsive to the player-input device 108, 208, to initiate display of one or more characters 132 (e.g., an animated object, humanoid or otherwise) in a three-dimensional environment 334 on the display 104, 110, 210, 212, 230, and to modify selected features of the character 132 responsive to one of an event occurring within the wagering game (e.g., a jackpot, entering a bet above a selected value, or activating the player input device 108, 208 in a selected manner, among others) or an event occurring within the three-dimensional environment 144, 334 (e.g., going from inside a building to outside, night changing to day, or temperature going from cold to hot, among others). Character features may include a color, a position, a velocity, a texture, a viewpoint, a rule of motion, a capability, a lifetime, a transparency, a size, an intelligence level, a gender, a strength level, a lifetime duration, or a shape, among others.

In some embodiments, the display 104, 110, 210, 212, 230 and/or the player-input device 108, 208, as well as the processor are included in a single enclosure 134 (e.g., a table-top cabinet, or a wireless hand-held game). The wagering game may be selected from slots, poker, black jack, roulette, bingo, and keno, among others. In some embodiments, the wagering game system 200 may further include a player-tracking device 244 to store information, including cumulative information, associated with the wagering game and an identified player, as described above. Such cumulative information may include characters, environments, features thereof, and other information particular to an identified player, or simply a unique identifier. Awards and bonuses may be responsive to the cumulative information, and vice versa.

The processor may also be used to evolve a feature of the character 132 in the three-dimensional environment 144, 334 to provide an evolved character 136, perhaps responsive to one of a plurality of sequential events occurring within the wagering game (e.g., a series of bets of increasing value, among others), or a plurality of sequential events occurring within the three-dimensional environment 334 (e.g., the passage of one “week” of game time, as a series of days, or the changing of seasons, among others). Evolution may occur in a manner similar to or identical to the evolution of character features in traditional role playing games and other games, such as the game Spore, developed by Maxis Studio and published by Electronic Arts, and known to those of ordinary skill in the art.

For example, a player may begin with developing a character 132 from some basic form, such as a cellular entity and, via evolution, eventually provide an evolved character 136 with more sophisticated brain functions that can manage technology and interact with other characters 132 in areas such as vehicles 146 that are provided, or have evolved within the three-dimensional environment 144, 334.

Characters 132 may “travel” between a variety of three-dimensional environments 144, 334, perhaps using a network 300 having a variety of gaming machines 306 coupled to it, wherein each gaming machine 306 has its own three-dimensional environment 334, such as a house, a vehicle, a farm, a town, a city, a suburb, a state, a country, a continent, an ocean, a planet, a satellite, or a star system. Travel may take place when one player permits the transport of a character 132 from one environment to another, perhaps by moving or copying the character 132 and its associated features to the second environment 334 from the first environment 144. Thus, characters 132 can populate, conquer, interact with, or merely observe the environments 144, 334 in which they are located. Environments 344, as well as characters, may be controlled by the local gaming machine 306, another gaming machine 306, or a server 308 that couples one or more gaming machines 306 to a network 300, including a peer-to-peer network.

Character meshes, textures, animations, feature acquisition, capabilities, and overall behaviors may be regulated by procedures (e.g., based on one or more sets of algorithmic rules), giving rise to virtually unlimited player-created content. The player-created content may be “owned” by an identified player, and perhaps shared among players. Such content, which may exist in the form of content libraries, may include individual characters, buildings, vehicles, entire civilizations, planets, and star systems. Ownership may also include the degree of mastery over the player interaction interface, which can become more complex as the scale of the environment increases.

Any of the components previously described can be implemented in a number of ways, including software embodiments. Thus, the gaming machine 100, 206, 306; coin slot 102; display units 104, 110; credit display 106; player input devices 108, 208; bet display 112; bet one button 116; cash out button 118; reels 120; readers/validators 122; bill acceptor 124; audio presentation units 128, 246; auxiliary video display 130; characters 132; enclosure 134; evolved character 136; three-dimensional environments 144, 334; vehicles 146; article of manufacture 202; gaming network 204; displays 210, 212; I/O bus 222; network interface unit 224; CPU 226; memory unit 228; video unit 230; nonvolatile memory 232; volatile memory 234; money/credit detector 214; touch screen 216; payout mechanism 218; information reader 220; graphics accelerator 240; machine-readable media 242; player-tracking device 244; instructions 291; wagering game network 300; cluster controller 308; wired connections 310; wireless connections 312; display device 320; player tracking system 324; and messaging systems 330 may all be characterized as “modules” herein.

Such modules may include hardware circuitry, and/or a processor and/or memory circuits, software program modules and objects, and/or firmware, and combinations thereof, as desired by the architect of the gaming machines 100, 206, 306, and as appropriate for particular implementations of various embodiments. For example, in some embodiments, such modules may be included in an apparatus and/or system operation simulation package, such as a software electrical signal simulation package, a power usage and distribution simulation package, a real-time telemetry simulation package, a power/heat dissipation simulation package, and/or a combination of software and hardware used to simulate the operation of various potential embodiments.

It should also be understood that the apparatus and systems of various embodiments can be used in applications other than for wagering gaming systems, and thus, various embodiments are not to be so limited. The illustrations of gaming machines 100, 206, 306 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, workstations, radios, video players, and vehicles, among others. Some embodiments include a number of methods.

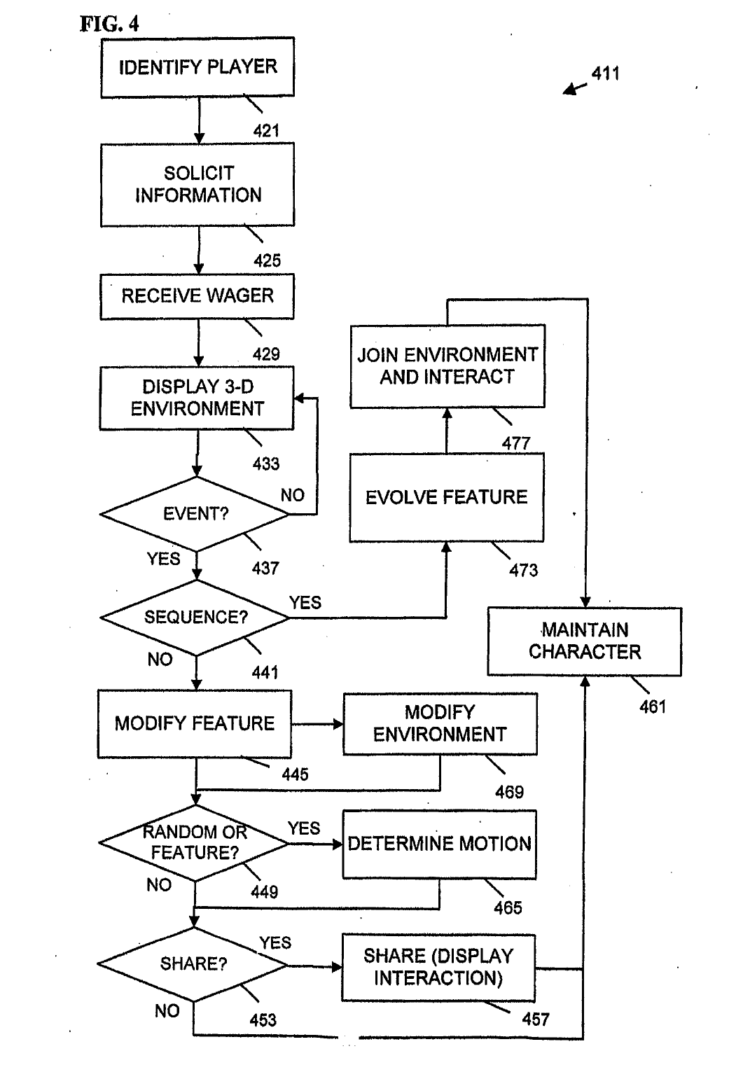

For example, FIG. 4 is a flow diagram illustrating several methods 411 according to various embodiments of the invention. For example, in a gaming machine that produces a gaming outcome, or receives a gaming outcome, and then displays the gaming outcome on a display, such methods 411 may include a variety of activities.

In some embodiments, the method 411 may begin at block 421 with identifying a player. This may occur in a number of ways, as described above, ranging from the use of a ticket, voucher, or credit card inserted into the gaming machine, to using biometric data, such as a retinal scan. The method 411 may continue at block 425 with soliciting information associated with an identified player, either directly or indirectly. Direct solicitation may occur by using explicit queries propounded to the player, such as “Do you prefer adventure games, or strategy games”? Indirect solicitation may occur by accessing additional information present in the gaming system or network, previously stored and associated with the identified player, such as a prior number of wins for a selected game, most-played game, etc. This information, obtained via direct or indirect solicitation, may be used to select an initial character for use in the three-dimensional environment, as well as various features of the character. Initial environments and features of environments may be selected in a similar fashion.

The method 411 may include receiving a wager to play a wagering game at block 429. The method 411 may continue at block 433 with conducting a wagering game (e.g., selected from slots, poker, black jack, roulette, bingo, and keno, among others) and displaying a three-dimensional environment associated with the wagering game (e.g., the gaming outcome). A character (e.g., a two-dimensional or three-dimensional animated character) may also be displayed in the three-dimensional environment, and the character may also be associated with the wagering game, including the gaming outcome.

If a selected event occurs in the wagering game (e.g., particular player activity detected via the player input device, or a particular game outcome as shown on reels, cards, dice, or some type of bonus game event], or a selected event occurs in the three-dimensional environment, or both, as determined at block 437, then the method 411 may continue on to block 441. If no such event is detected, the method 411 may go back to block 433.

At block 441, the method 411 may include determining whether one of a plurality of sequential events have occurred within the wagering game, or one of a plurality of sequential events have occurred within the three-dimensional environment. If not, then the method 411 may continue on to block 445, where one or more features of the character may be modified in response to the event detected at block 437. As noted above, character features may include one or more of a color, a position, a velocity, a texture, a viewpoint, a rule of motion, a capability, a lifetime, a transparency, a size, an intelligence level, a gender, a strength level, a lifetime duration, or a shape, among others. Features may be modified in response to a number of events or information, including information associated with an identified player. The method 411 may also include, at block 469, modifying one or more features of the three-dimensional environment responsive to detecting the presence of one or more features of the character.

If one or more events in a selected sequence are detected at block 441, then the method 411 may include evolving a feature of a character in the three-dimensional environment to provide an evolved character, perhaps in response to one of more of the events detected in the selected sequence (either occurring within the wagering game or the three-dimensional environment) at block 473. Features of characters may be evolved in response to any number of events or information, including information associated with an identified player.

As noted above, characters developed in an environment may interact with the environment, and with other characters. Thus, the method 411 may continue at block 477 with joining an environment created by one player to an evolved character to interact with another character created by another player.

As those of ordinary skill will realize after reviewing the details of this disclosure, an almost unlimited variety in the sequence of a wagering game may be realized using the principles described herein. For example, at block 449, the method 411 may include determining whether a random element or a feature of the three-dimensional environment, or both, are present, and then, at block 465, determining some component (e.g., velocity, acceleration) of the character's motion, or any other feature, accordingly. This may include a variety of activities, such as slowing a character down in the cold, or rainy weather, or the dark, or speeding a character up in the heat, or on a solid surface, etc.

At block 453, it may be determined whether the player wishes to share a character he has developed outside of the three-dimensional environment currently in play. Thus, the character, including modified or evolved features, may be copied or moved to another wagering game having another environment when the same player returns, or even to a wagering game initiated by other players. Thus, if it is determined that the modified or evolved character will be shared at block 453, then the character created by a first player may be shared in the same three-dimensional environment (or a different environment) with a second player at block 457, for example, and then the method 411 may include displaying an interaction between the character created by the first player in the three-dimensional environment and a second character created by the second player. Whether or not a modified or evolved character is shared, it may be maintained across a series of completed gaming sessions associated with the wagering game and a unique identifier (e.g., associated with a selected player or identification number) at block 461.

It should be understood that the operations of the flow diagrams can be performed by embodiments of the invention other than those discussed with reference to the block diagrams, and embodiments discussed with references to the block diagrams can perform operations different than those discussed with reference to the flow diagrams. Additionally, some embodiments may not perform all the operations shown in a flow diagram.

Further, it should be noted that the methods described herein do not have to be executed in the order described, or in any particular order. Moreover, various activities described with respect to the methods identified herein can be executed in iterative, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment. Thus, other embodiments may be realized.

For example, by referring back to FIG. 2, it can be seen that some embodiments of the invention may include an article 285 according to various embodiments, such as a computer, a memory system, a magnetic or optical disk, some other storage device, and/or any type of electronic device or system. The article 285 may include a processor (e.g., CPU 226) coupled to a machine-accessible medium 242 such as a memory (e.g., removable storage media, as well as any memory including an electrical, optical, or electromagnetic conductor) having associated information 291 (e.g., computer program instructions and/or data), which when accessed and executed by the processor, creates a system for executing the various methods described previously.

For example, executing the instructions stored on the medium 242 may result in a machine (e.g., the gaming machine 206) performing such actions as receiving a wager to play a wagering game, displaying a character in a three-dimensional environment associated with the wagering game, and modifying a feature of the character responsive to an event occurring within the wagering game or the three-dimensional environment. Further actions may include soliciting information associated with an identified player, and modifying one or more features of the character responsive to the information associated with the identified player.

In some embodiments, executing the instructions stored on the medium 242 may result in a machine performing such actions as executing a method including receiving a wager to play a wagering game, displaying a three-dimensional environment associated with the wagering game, and evolving a feature of a character in the three-dimensional environment to provide an evolved character responsive a plurality of sequential events occurring within the wagering game or the three-dimensional environment. As noted previously, the wagering game may be selected from the group including slots, poker, black jack, roulette, bingo, and keno, among others. Other actions may include evolving the evolved character responsive to information associated with an identified player, for example. Additional embodiments may be derived by reviewing the descriptions of various methods given above.

Implementing the apparatus, systems, and methods of various embodiments may enhance the interaction between characters, gaming outcomes, and three-dimensional visual environments in a wagering game, so as to increase player interest through additional opportunities for player-game interaction.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Thus, in some instances, well-known circuits, structures and techniques have not been shown in detail so as not to obscure understanding of the various embodiments. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. In a gaming machine that displays a gaming outcome on a display, a method comprising:
receiving a wager to play a wagering game;
displaying a character in a three-dimensional environment associated with the wagering game; and
modifying a feature of the character responsive to one of a monetary event occurring within the wagering game or an event occurring within the three-dimensional environment.

2. The method of claim 1, wherein the feature of the character includes at least one of a color, a position, a velocity, a texture, a viewpoint, a rule of motion, a capability, a lifetime, a transparency, a size, an intelligence level, a gender, a strength level, a lifetime duration, or a shape.

3. The method of claim 1, further including:
sharing the character created by a first player with a second player.

4. The method of claim 1, further including:
displaying an interaction between the character created by a first player in the three-dimensional environment and a second character created by a second player.

5. The method of claim 1, further including:
maintaining the character across a series of completed gaming sessions associated with the wagering game and a unique identifier.

6. The method of claim 1, further including:
modifying a feature of the three-dimensional environment responsive to the feature of the character.

7. The method of claim 1, wherein a motion of the character is determined according to one of a random element or a feature of the three-dimensional environment.

8. In a gaming machine that displays a gaming outcome on a display, a method comprising:
receiving a wager to play a wagering game;
displaying a three-dimensional environment associated with the wagering game; and
evolving a feature of a character in the three-dimensional environment to provide an evolved character responsive to one of a plurality of sequential monetary events occurring within the wagering game or a plurality of sequential events occurring within the three-dimensional environment.

9. The method of claim 8, further including:
sharing the evolved character created by a first player with a second player.

10. The method of claim 9, further including:
joining an environment created by the first player to the evolved character to interact with another character created by the second player.

11. The method of claim 8, further including:
maintaining the evolved character across a series of completed gaming sessions associated with the base game and a uniquely identified player.

12. A wagering gaming system, comprising:
a player-input device;
a display; and
a processor to conduct the wagering game responsive to the player-input device, to initiate display of a character in a three-dimensional environment on the display, and to modify a feature of the character responsive to one of a monetary event occurring within the wagering game or an event occurring within the three-dimensional environment.

13. The wagering gaming system of claim 12, wherein the display and the processor are included in an enclosure.

14. The wagering gaming system of claim 12, wherein the wagering game is selected from the group consisting of slots, poker, black jack, roulette, bingo, and keno.

15. A wagering gaming system, comprising:
a player-input device;
a display; and
a processor to conduct the wagering game responsive to the player-input device, to initiate display of a character in a three-dimensional environment on the display, and to evolve a feature of the character in the three-dimensional environment to provide an evolved character responsive to one of a plurality of sequential monetary events occurring within the wagering game or a plurality of sequential events occurring within the three-dimensional environment.

16. The wagering gaming system of claim 15, wherein the player-input device and the processor are included in an enclosure.

17. The wagering gaming system of claim 15, further including:
a player-tracking device to store cumulative information associated with the wagering game and an identified player.

18. An article comprising a machine readable medium having instructions stored thereon, wherein the instructions, when executed by a processor, create a system for executing the method of:
receiving a wager to play a wagering game;
displaying a character in a three-dimensional environment associated with the wagering game; and
modifying a feature of the character responsive to one of a monetary event occurring within the wagering game or an event occurring within the three-dimensional environment.

19. The article of claim 18, wherein the instructions, when executed by a processor, create a system for executing a method, including:
soliciting information associated with an identified player.

20. The article of claim 19, wherein the instructions, when executed by a processor, create a system for executing a method, including:
modifying the feature of the character responsive to the information associated with the identified player.

21. An article comprising a machine readable medium having instructions stored thereon, wherein the instructions, when executed by a processor, create a system for executing the method of:
receiving a wager to play a wagering game;
displaying a three-dimensional environment associated with the wagering game; and
evolving a feature of a character in the three-dimensional environment to provide an evolved character responsive to one of a plurality of sequential monetary events occurring within the wagering game or a plurality of sequential events occurring within the three-dimensional environment.

22. The article of claim 21, wherein the wagering game is selected from the group consisting of slots, poker, black jack, roulette, bingo, and keno.

23. The article of claim 21, wherein the instructions, when executed by a processor, create a system for executing a method, including:
evolving the evolved character responsive to information associated with an identified player.
